(19) United States
(12) Patent Application Publication
(10) Pub. No.: US 2005/0188054 A1
(43) Pub. Date: Aug. 25, 2005

(54) Http message compression

(75) Inventors: Janne Riihijarvi, Aachem (DE); Zach Shelby, Oulu (FI); Petri Mahonen, Aachen (DE)

Correspondence Address: BANNER & WITCOFF, 1001 G STREET N W, SUITE 1100, WASHINGTON, DC, 20001, US

(73) Assignee: NOKIA CORPORATION, Espoo (FI)

(21) Appl. No.: 10/505,975

(22) PCT Filed: Feb. 28, 2002
(86) PCT No.: PCT/IB02/00596

(51) Int. Cl. G06F 15/16

(52) U.S. Cl. 709/218

(57) ABSTRACT

Method for compressing a HTTP message, including at least one field name and at least one field value, comprising Receive parsing said HTTP message, to identify said at least one field name and said at least one field value, mapping each field name onto at least one binary octet (byte), the most significant bit (MSB) of said octet being set to “one”, mapping each field values onto at least one binary octet (byte), the most significant bit (MSB) of said octet being set to “zero”, and outputting said binary octets (bytes) to provide the HTTP message in compressed format. The method uses binary tagging instead of complex compression algorithms, making it extremely efficient if the processing power requirements (low) or latency-time (low) is considered.

### TECHNICAL FIELD

The present invention relates to a method for compressing a HTTP-message.

### TECHNICAL BACKGROUND

The Hyper-Text Transfer Protocol (HTTP) is a text rich application protocol developed for moving documents across the World Wide Web. Small ubiquitous and pervasive computing devices and (wireless) sensors usually have very limited processing power and only narrowband connectivity to a network. For this reason, compression of some kind is advocated.

The trend in the field has been to study only transmission protocol compression (e.g. IP header compression). However, this is not enough, as HTTP (in the payload) will dominate the traffic overhead. Therefore, compression of HTTP, which is and will be used extensively for many ubiquitous and wireless applications, is required.

An example of a compression method which can be used for HTTP compression, is given in WO 00/67382. According to this method, the fields of a HTTP header are coded by means of code words. Although a HTTP message can be compressed with the described method, the compression is insufficient, as the method is not specifically highly optimized for small devices and low bit-rate communication.

### SUMMARY DISCLOSURE OF THE INVENTION

An object of the invention is to effectively compress the HTTP header, using very limited processing power and latency.

This and other objects are achieved with a method for compressing a http-message, including at least one field name and at least one field value, comprising parsing said HTTP message, to identify said at least one field name and said at least one field value, mapping each field name onto at least one binary octet (byte), the most significant bit (MSB) of said octet being set to “one”, mapping each field values onto at least one binary octet (byte), the most significant bit (MSB) of said octet being set to “zero”, and outputting said binary octets (bytes) to provide the HTTP message in compressed format.

Thus, according to the invention, the MSB of each octet (byte) is used to indicate whether a particular octet relates to a field name or a field value. As the MSB indicates when the field-name ends, and respectively when the field-value ends, there is no need for separators such as “:” and CRLF. In addition, most field-values (such as language tags, character sets etc.) can be easily enumerated, with most common values fitting in the 0-127 range, so that the entire header field can often be compressed into just two octets. Even for free-formed field-values (such as strings occurring in the Host-header) no special encoding is required, as they often consist of alphanumeric characters which can be sent with seven bits using e.g. ASCII code.

The method uses binary tagging instead of complex compression algorithms, making it extremely efficient if the processing power requirements (low) or latency-time (low) is considered. Hence, the low processing power and latency requirements have been taken as priority compared with the traditional full text compression approach.

The most obvious advantage of the invention is the high level of compression achieved. Instead of using three octets for separators, usually at least one for white space, and 2-19 octets for field-name specification, only one octet is used. Even for field-values large compression factors are obtained for content encoding, media types etc. Thus the overall compression factor is usually quite high.

Also parsing the compressed message is, in most cases, extremely simple compared to parsing the case-insensitive ASCII field-names. A parsing algorithm can very easily distinguish between field names and field values, regardless of their length.

In order to get an apprehension of the improvements in compression rate, the method according to the invention can be applied to the HTTP message illustrated on page 14-15 of WO 00/67382, hereby incorporated by reference. While the method according to WO 00/67382 results in a compression rate (percentage of original message length eliminated) of 64%, the method according to the present invention results in a compression rate of 73%. Note, however, that these figures are only an example, and depend on the message to be compressed. Other examples can be found, where the improvement is significantly larger.

Currently, many devices on the Internet make use of proxies for various reasons. The smallest devices will especially be forced to use proxies, gateways, and/or split protocol stacks in the future. This is to add security, caching capability, or to provide addresses to devices. The method according to the invention is easy to implement as part of this proxy approach. The proxy device will handle the most complex part of the algorithm. The compression can be implemented with simple look-up tables, with minimal complexity added to normal parsing of the HTTP-message.

The invention offers an efficient way to enable the use of HTTP and all applications based thereon in very cost efficient devices, and the possibility to embed compression functionality into split protocol stack communication paradigms. It is especially valuable for low communication speed links and small embedded devices/sensors.

As the method leads to more efficient packaging, and faster and less complex parsing, it is advantageously used in small devices.

The HTTP message can be a request message, including a request method, a URI, and a http version identifier. In this case, the method can comprise treating said request method and said HTTP version identifier as a field name, mapping them onto at least one binary octet with its MSB being set to “one”, and treating said URI as a field value, mapping it onto at least one binary octet with its MSB being set to “zero”.

The URI can be mapped using conventional ASCII characters, i.e. one octet (byte) for each character, with the MSB set to “zero”. However, it is also possible to map particular parts of the URI, such as “HTTP://”, or entire URI:s, onto one singe octet.

The HTTP message can also be a respond message, including a http version identifier, a status code, and a status message. The method can then comprise treating said status code and said http version identifier as a field name, mapping them onto at least one binary octet with its MSB being set to “one”, and treating said status message as a field value, mapping it onto at least one binary octet with its MSB being set to “zero”.

### BRIEF DESCRIPTION OF THE DRAWINGS

A currently preferred embodiment of the present invention will be described in the following with reference to the appended figure, where

FIG. 1 is a schematic view of an environment where the method according to the invention may be implemented and

FIG. 2 is a flow chart of a method according to an embodiment of the invention.

### DETAILED DESCRIPTION OF PREFERRED EMBODIMENTS

The following binary compression scheme is based on HTTP/1.1, however the same technique applies to older and future versions.

An HTTP-message consists of a start-line, message-header, and message-body. The disclosed invention is only concerned with compressing the start line and message header.

The message-header in HTTP/1.1 consists of fields of the form
field-name “:” [field-value]
with possibly some white space without semantic content. Fields are separated by CRLF sequences.

According to the invention, each field-name is mapped to an octet with the most significant bit (MSB) set, while field values get mapped to sequences of octets with the highest bits set to zero. No CRLF is needed.

If, for example, the field name “Content-Length” is mapped to [10010011], the field
Content-Length: 8200 CRLF,
   where CRLF indicates “cariage return”, would be mapped to
[10010011]—Content length
[01000000]—64
[00001000]—8 (8200=64*128+8).

With the MSB indicating a field name, seven bits remain for coding the field name itself, in other words the code will allow for 128 field names. In the case of full HTTP/1.1 there are only 47 predefined header field names. If more that 128 distinct field-names need to be conveyed, multiple octets with MSB set could be concatenated.

A special octet, such as [11111111], can indicate the end of the message-header (this could be omitted if the message-body is empty), and some other special bit sequence, such as [10000000], could act as the “,” of http, if this is deemed necessary.

The start line of a HTTP message is different depending on whether the message is a request message or a respond message.

For requests, the start-line is of the form:
Method SP Request-URI SP HTTP-Version CRLF,
   where SP indicates “space” and CRLF indicates “carriage return”.

The proposed compression scheme is to handle the method and the HTTP-Version (HTTP/1.1 in our case) as a combined field-name, and the Request-URI as the field value. Preferably, the first part of the field name octet (e.g. the six first bits) indicate the method, and the last part (e.g. the two last bits) indicate the HTTP version.

If GET is mapped onto [100001] and HTTP 1.1 is mapped onto [01], then, as an example,
GET http://www.oulu.fi HTTP/1.1
would become
[10000101]—GET and HTTP-version
[01101000]—h
[01110100]—t
[01110100]—t
[01110000]—p
[00111010]—:
[00101111]—/
[00101111]—/
[01110111]—w
[01110111]—w
[01110111]—w

Alternatively, an optional shorthand can be adopted for the most common protocol identifiers, such as [11000001] for http://.

Further, it is possible for the proxy to define shorthands for commonly used URIs of a device. Thus, if a URI such as http://our.server/camera/current.html was mapped onto [00000001], then
GET http://our.server/camera/current.html HTTP/1.1
could be compressed quite simply as
[10000101][00000001].

If more than 24 extension methods are needed, or a new HTTP-version provides added functionality, the combined method/version field-name could again span multiple octets (with highest bits set to 1) to give enough space for enumerating the new methods.

For responses, the start-line reads
HTTP-Version SP Status-Code SP Status-message CRLF,
   where, again, SP indicates “space” and CRLF indicates “carriage return”.

The compression can again be achieved, for example, by combining the HTTP-Version and Status-Code as a field-name, and giving the Status-Message as an optional value for that header.

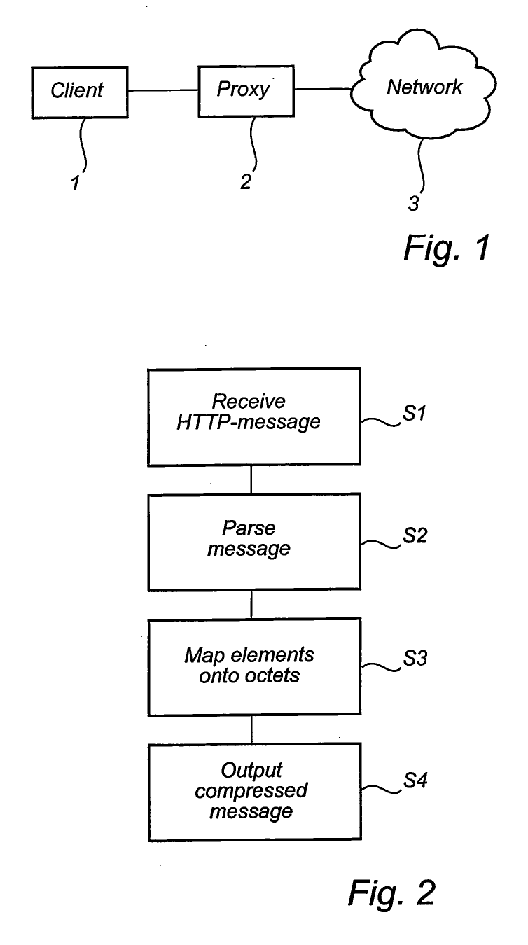

With reference to FIG. 1, the method can advantageously be implemented in the communication between a client device 1 (such as a PDA or sensor) and a proxy 2, located intermediately between the client 1 and a network 3. The method may be implemented by software, being run on microprocessors or -controllers in the proxy and device respectively, but it may equally well be implemented by programmable logic circuits (FPGA), electronic components, or as part of ASIC-circuitry.

With reference to FIG. 2, the proxy receives (S1) a HTTP message from the network, and parses it (S2) in order to identify the field names and field values. Note that, according to the preferred embodiment, the start line (request or response) is also identified as comprising field name and field value, as was described above.

In the next step (S3), the parsed elements are mapped onto binary octets (bytes) using e.g. look-up tables, and the compressed message is outputted (S4).

The client receives the compressed message, and can very effectively parse it and identify the HTTP elements using an identical set of look-up tables.

A similar routine can be followed when sending HTTP messages from the client to the proxy. A HTTP message is compressed by the client, and sent to the proxy. The compressed HTTP message will be received by the proxy, and decompressed using the same look-up tables.

Alternatively, applications on the client side can be adapted to receive and generate HTTP messages directly in compressed format, to save processing resources.

The above description of a preferred embodiment is not intended to limit the scope of the appended claim, and many modifications will be apparent to the skilled person. For example, it is not necessary to use the MSB as “recognition bit”, indicating the occurrence of field names, but instead this can be coded in any other place.

1. Method for compressing a HTTP message, including at least one field name and at least one field value, comprising
parsing said HTTP message, to identify said at least one field name and said at least one field value,
mapping each field name onto at least one binary octet (byte), the most significant bit (MSB) of said octet being set to “one”,
mapping each field values onto at least one binary octet (byte), the most significant bit (MSB) of said octet being set to “zero”,
and outputting said binary octets (bytes) to provide the HTTP message in compressed format.

2. Method according to claim 1, further comprising mapping each field name into two octets, each having their respective MSB set to “one”.

3. Method according to claim 1, wherein said HTTP message is a request message, including a request method identifier, a URI, and a HTTP version identifier, comprising
identifying said request method identifier and said HTTP version identifier as a field name, mapping them onto at least one binary octet with its MSB being set to “one”, and
identifying said URI as a field value, mapping it onto at least one binary octet with its MSB being set to “zero”.

4. Method according to claim 1, wherein said HTTP message is a respond message, including a HTTP version identifier, a status code, and a status message, comprising
identifying said status code and said HTTP version identifier as a field name, mapping them onto at least one binary octet with its MSB being set to “one”, and
identifying said status message as a field value, mapping it onto at least one binary octet with its MSB being set to “zero”.
